(19) United States
(12) Patent Application Publication
(10) Pub. No.: US 2023/0237453 A1
(43) Pub. Date: Jul. 27, 2023

(54) SMART SYSTEM FOR TRANSFERING AND EXCHANING GOODS AND SERVICES IN THE FINANCIAL PLATFORM

(71) Applicant: Shahab Marzani, Tehran (IR)

(72) Inventor: Shahab Marzani, Tehran (IR)

(21) Appl. No.: 18/011,201

(22) PCT Filed: Jun. 22, 2020
(86) PCT No.: PCT/IB2020/055854

§ 371 Date: Jan. 15, 2023

(51) Int. Cl. G06Q 20/12; G06Q 20/38

(52) U.S. Cl. CPC G06Q 20/12; G06Q 20/381

(57) ABSTRACT

The invention of smart system for transferring and exchanging goods and services in the financial platform is an application to create the possibility for interactions among people and especially it is a web-based system for informing, identifying and exchanging services, goods and liquidity resources with each other which this exchange can be based on the existed credit in the system. This system is equipped with a value and credit creating structure based on the performed interactions. The operating observation port for the users can be various types of websites or installable applications on the personal equipments including mobiles, tablets, phone pads, different types of PCs and any system and structure usable in cyber space. The said system is usable for users with any nationality and language. In this system each person states and files his request by announcing his ability to do a service or based on another good.

### TECHNICAL FIELD OF THE INVENTION

The present invention relates to the field of web-based interaction and also relates to the financial and non-financial exchanging systems as well as barter exchanges and also related to the field of learning machine and expertly relates to the web-based system for informing, identifying and exchanging services, goods and liquidity resources with each other.

### PRIOR ART

Financial transactions as well as exchanging goods and services, from past, have been a way for human to obtain their needs through providing it by their congeners. At first, exchanges were generally based on exchanging goods for goods and done in the form of bartering. With the development of human knowledge, the first sparks of facilitation in transactions and exchanges were formed between members of society.

Generally at this moment, the valuation is done by sellers and buyers adoptively. With the promotion of human industrial capabilities and invention of money, exchanging goods and services versus reception of funds including cash in the form of monies, paper currencies, financial credits, bills of exchange, checks and promissory notes or web-based monies were possible, but the progress of transactions was limited to cash exchange. Human beings then invented the computer and developed its technology and created interactive structures to exchange goods and services with financial resources. The result of revolution of financial transactions is the creation of web-based structures for buying and selling, supplying and providing goods and services and transferring these recourses. In this area, the done actions results to some of following in the form of innovations and patents.

An invention with U.S. Pat. No. 7,487,123 patent number, dated Feb. 3 2009, filed in USPTO is a computer-implemented financial management system provides the trading of securities via a network using virtual currency. A server computer receives buy and sell orders for derivative financial instruments from a plurality of client computers. The server computer attempts to match the buy and sell orders and then generates a market price through the use of a virtual specialist program executed by the server computer. The virtual specialist program responds to an imbalance in the matching of the buy and sell orders. The virtual currency accumulated by HSX account holders as a result of successful trading may be converted to another currency, credited toward the cost of merchandise provided through a vendor's web site. This system works as a market expert.

Also in an invention with US20010054006A1 publication number, dated Dec. 20, 2001, filed in USPTO provided a points trading service method which includes the steps of collecting information on a customers' trading points total from a member shop and storing the information in a customer database; receiving information on a points trade request from a customer; and trading points with other customers according to the points trade request. According to the method of the present invention, a customer can redeem a small amount of points into cash and exchange the points the user does not want to use for other points. Upon collecting trading points, a customer can also use the cyber money or points at a plurality of member shops. Therefore, when the method according to the present invention is applied, Internet business marketing and cyber money use can be extended and promoted.

Also the invention with US20160125513A1 publication number, dated May 5, 2016, filed in the USPTO is related to the systems and methods for classification, viewing, sorting, rating, ranking, listing, selling and acquiring goods in a consumer to consumer marketplace, which provide for an individual the ability to browse goods through a number of different communities, both geographical and otherwise, and further including custom communities. The systems and methods further comprise a unique user storefront, which may further be customized to meet the individual user's needs and wants. The systems and methods described herein further provide a user with the ability to define parameters associated with a particular community, group or subgroup and invite other user to join the community, group or subgroup. The payment can be in the form of cash or online payment. The buyer can rate to the transaction and good in that system.

The invention with US20170372392A1 publication number, dated Dec. 28, 2017, filed in USPTO is a safe method for exchanging goods and storing information and the related rules in a database. In this server each exchange good appear with issue information and serial number. The method continues with an enterprise server initially validating exchange items and creating records in the exchange item database for validated exchange items, where each of the exchange items includes data regarding a quantifiable value, a serial number, and issuance information. The method continues with the enterprise server securely transferring a selected exchange item from a first computing device to a second computing device in accordance with an offer for sale of the selected exchange item and securely applying the selected exchange item to a closed loop digital transaction between two computing entities in accordance with an agreement of the agreements database.

Also an invention with U.S. Pat. No. 6,594,640 patent number dated Jul. 15, 2003 filed in USPTO is a system and method for operating a reward points accumulation and redemption program wherein a user earns reward points from a plurality of independent reward points issuing entities, with each tracking the user's earned reward points in a user reward point account stored on a rewards server (such as a frequent flyer account or a credit card loyalty account). A trading server accumulates some or all of the user's earned reward points from the reward servers and credits the accumulated points into a single reward exchange account associated with the user. The user may then select an item for purchase with the accumulated reward points. The item is provided to the user in exchange for a subset or all of the reward points.

In an invention with US20120078700A1 publication number, dated Mar. 29, 2012 filed in USPTO is a system and method for supporting existing merchants and malls to better serve customers by providing easy access to merchandise and sales assistants over a communication network in order to display items dynamically and to provide expert information on products. The shopping experience is enhanced by a portable client identification to allow ease of shopping and checkout. For items purchased that need installation or service or support, access to live experts is provided. Direct connection to service providers is available over the network. If a shopper does not find the desired merchandise he is referred to another merchant who has the product with the referring merchant receiving a commission or other consideration.

Also in another invention with US20140207557A1 dated Jul. 24, 2014, provide an online bartering service, filed in USPTO. The online bartering service may include registering a trading coupon of first user equipment in response to a registration request from the first user equipment, providing information on a list of candidate coupons to the first user equipment based on information on the trading coupon of the first user equipment, receiving a trading offer message with information on a selected candidate coupon from the first user equipment and transmitting the trading offer message to second user equipment having the selected candidate coupon, and automatically processing a difference between the trading coupon and the selected candidate coupon in connection with associated virtual accounts upon receiving a trading acceptance message from the second user equipment.

The invention with US20160350835A1 application number, dated Dec. 1, 2016 filed in USPTO provides a computerized based system and method invention for trade-in bartering items between two or more parties using Smartphone/mobile device application. All parties access a central server via Smartphone/mobile device application and provide a list of items they have to trade-in and want to obtain, a description of the items and any conditions for trade-in of the items. The lists are stored in a database to indicate the party's possible trades are automatically created. A heuristic based system checks for possible trades between the parties. There isn't any dispute about digital currency in this method.

Also another invention with WO2004027660A2 patent number, dated Apr. 1, 2004, filed in WIPO, named Trading or barter system using a combination of real and trade currency is a method for the exchange of goods and/or services in a trading exchange using a combination of trade and real dollars and having a plurality of trading members, whereby a trading member obtaining goods and/or services from another trading member pays for those goods and/or services using a combination of real and trade dollars according to the category of the trading member supplying the goods and/or services.

Also in the other invention with DE112008003980T5 patent number, filed in Germany's Patent Office an online trading system accessible to a plurality of end users is provided, where nodes of the hierarchy define respective article and/or service groups with progressively increasing levels of detail, including articles and/or services that are offered for trading in the system are directly associated with at least one group. Each request identifying one or more parameter fields for describing articles or services belonging to the group and one or more positions within the hierarchy of the existing group.

In an invention with U.S. Pat. No. 6,507,823 patent number, dated in Jan. 14, 2003 in the USPTO provides a method of conducting a financial transaction between a purchaser and a vendor of a product, the purchaser and the vendor each having an account held at respective first and second financial institutions. The method requires the provision of at least one vendor database 24 including product-related information, for example regarding the availability and price of a product. A publicly accessible data exchange terminal, typically an automatic teller machine (ATM), is linked to the vendor database. The purchaser filed his request to obtain information about the transaction and several options are displayed for the trading.

And also in another invention with U.S. Pat No. 4,992,940 patent number, dated Feb. 12, 1991, filed in the USPTO is an automated system assists a user in locating and purchasing goods or services sold by a plurality of vendors. The system includes a programmed computer which is linked to a database. The database contains information about a large number of different products and/or services, arranged in various categories. For each product or service, the database contains information on price, vendor, specifications and/or availability. In operating the system, the user first indicates the general type of product or service desired. The system responds by displaying a template giving specifications for the type of product or service selected. The user then fills in one or more blank spaces in the template, to tell the system the minimum desired specifications for the product or service. The computer then searches the database to retrieve all products or services, within the product or service category selected, having the specifications required by the user.

Also the website www.swapz.co.uk is a kind of website for exchanging goods for goods, purchasing goods or providing goods.

Generally the base of almost most web-based structures in financial interactions is based on exchanging money or liquidity for services, goods or other resources of the liquidity. For this reason, among problems in the present method can mention to impossibility of designed and customized interactions.

### DESCRIPTION OF THE INVENTION

The present invention is a combinational and smart structure from aggregation of methods and different ways in defining online trading, in this way that the present invention has a software structure on a specific server which all interactions except physical interactions carry out in the existed platform. In this invention, the operating observation port for the users can be various types of websites or installable applications on the personal equipments including mobiles, tablets, phone pads, different types of PCs and any system and structure usable in cyber space.

On the main software, there are numbers of different spaces for keeping information. Among these databases can mention to the database of keeping user's information. Also the database related to the presentable goods or services in this invention can be another type of keeping structure. Also the database related to the background of individual's transactions as well as the database related to the financial account of individuals can be included in the keeping information structures.

Graphical structure of the present invention is not limited to a specific form or format as well as its operation and disposure structure which is not limited to a specific language. Thus the users of the present invention with any nationality and language can communicate with other nationalities and languages.

Software structure of the present invention is equipped with a smart translator among different languages. Thus, if the users of the present system enter with any language from anywhere, is allowed to provide information, file a request, and do a transaction as well as exchanging information, financial cases and other structures. Also the present invention equipped with a searching motor for searching and finding common requests of its users, which this searching motor performs based on checking predefined items as well as exploited information based on interpretation of filed request or offered suggestion.

Also the present invention is equipped with a value and credit creating structure based on the performed interactions, and also the present invention in order to facilitate the financial operations makes it possible to do these operations in the invention platform without the need to financial structures outside the organization.

Among the capabilities of the present invention is the possibility of bartering between members and creation barter trade structure. Also it will be possible to convert the created value into currency and vice versa i.e. converting the currency into the created value in the system of the present invention and also the possibility of allocating special codes and different methods of entering these codes into the software is available.

By entering a user into the present invention through the input port (website or application), the user is first forced to submit their information. In this section, the natural or legal person can log into the system and do their initial registration.

All the required information concerned to the user person is registered in his account and this information can be detailed and classified as necessary. After completing the account, the user receives a unique identifier except username and password which this unique identifier minimize the possibility of errors in financial operations or errors in sending and receiving information related to a specific transaction. In this way that at the time of a transaction, the server, apart from username and password, requests this special code from the parties and it allows the transaction to be performed based on verification and validity of the said code and according to correct identifying of the parties and their approval, the required transaction occurred. The use of common facial recognition mechanisms, fingerprints, iris scanning or other diagnostic structures can help for better recognition of users as an auxiliary mechanism next to this system.

Among the benefits of using this system is the possibility of bartering of goods or services or goods and services with each other or goods and services with digital and cyber money or a combination of all items in multiple forms. For instant consider 3 persons which the first person gives the good to the second person and the second person gives it to the third person and the third person gives the good to the first person. It is also possible to make maximum use of potential of capabilities, occupations as well as the available facilities among users and can use the empty existing potential. Also the entrepreneurship of this structure can maximize the possibility of exploitation of member's intangible potential.

Generally can consider the present invention in the form of a system for exchanging goods for goods, goods for services or services for goods. The present invention comprise from a central server and different interactional ports. The software of the present invention runs on the main server and under a specific application make it possible to connect to the mobile phones, tablets, phone pads and PCs. Each user can be registered by providing personal particulars at the beginning of entering to the said system structure. An information translator and updater system can convert any type of information provided by the user into an international language or a machine code language. Now it is time to compare the requests provided in the present invention. The choice of method and type of interaction among people usually made by them. In this way, each person states his request to receive certain goods, services or interactions and announces his ability to pay the value of his request, for instant an individual which request to purchase a specific car can announce his ability to do constructional work or carpentry quid pro quo for that car. If the person who has the possibility of the mentioned interaction is found, the connection between these two people for the desired transaction will take place. If the type of request and used vocabulary finally concluded to an interaction, the system develops and evolves itself in the form of learning machine and along with a related dictionary for converting words and statements to a specific machine code language. This evolvement is in line with intelligent promotion of the system and is based on a kind of artificial intelligence.

In general, there is a port which responds to any necessity. These necessities are divided into two categories, supply and demand. Each time, in one side there is demandant which in the form of filling a pre-designed form, state his/her need.

Then, by filling the request form, it would be possible for the structure of the invention to automatically review the information. The presented request converts into a set of comprehensible codes for server. Then, said codes can create somehow a correct connection between the request and defined international language using the complier and machine code language with the information in the database, smart translator of the system as well as background and coincidence resulting in interaction between the users. Now according to the type of user's request, the system will review all requests and if two requests accommodate with each other in such a way that the provided services or the offered goods in these two requests supply another request and this interaction clearly declare to the users. Also due to the lack of 100 percent accommodation of declared items, it may not be possible to provide the declared necessities. At this time the structure of the present invention can offer the closest suggestions to the user's request using artificial intelligence and past experiences as well as choices. At this time the presented goods or services or the announced liquidity may consider as one side of the barter.

As mentioned earlier, the offered service, good or credit in the structure shall be exchanged or paid for via the consumer with another good or other services, money or credit made in the system of the invention.

For instant in one sample of a provided service, our demand concord with a supply. When click on the supply, some information like image, details of the transaction or determined ways of the payment, contact information after speak of two parties in case of telephone agreement, or since this is a service without the risk of misusing by the other party, and if there is no need to a phone call, the person will submit his/her request to buy or give that service or good to the other party. After that if the second party wants to exchange or make a transaction with the first party, click on the word “guaranty” or validation. Now consider that this transaction is for exchanging a ring worth 200 units for a cell phone worth 400 units. In order to prevent possible misuse toward overstating the actual value of the good, both parties must be committed beside the receiving goods and the first party must have 400 units and the second party 200 units credit in the system of the present invention in order to allow the return of the good or providing the occurred damage to the other party in case of possible fraud (this amount of credit must be crisscross i.e. everyone must have credit for one of the possible types in relation to the value of the goods they want to receive). As mentioned before for long term exchanges, this amount can be the amount of price of good plus the amount of differences in prices in the volume of exchange.

In the area of services, this guarantee is needed again for the requested services. For instant one is a gardener and another is a carpenter. The value of what gardener is going to do for the carpenter is agreed upon by parties and the carpenter obliged to pay that amount depending on the specific work. Now the carpenter must have that amount in any provided type in his/her account in the structure, so that if the gardener does the work and the carpenter doesn't do the work or for another reasons, the gardener can get his remuneration from that credits.

In the structure of the present invention, this guaranty is also required for the long term jobs to run than other services.

By entering the system through website or the application the person shall be subscribe or enter with the pre-registered username and password. The registration information contains first name, surname, mobile number to receive the code and Google or Facebook account. Additional information such as bank account and other required information will be enrolled by the user in the future when access to the transaction.

In the structure of interactional port provided for the user, the next page is a completely simple page comprises numbers of items in the middle and the language icons in other parts of the page. These items involve the categories of supplies, messages, demands, a general category and a search bar.

In the category of demands, information is divided into several sub-categories which include adding a request, previous demands, others demands in relation to the made supplies. First these demands are displayed randomly because a demand is not yet registered. In this case the advertisement paid by customers can be displayed.

The category of supplies is the same as demands. In the general category all advertisements are displayed randomly and according to the policy of the complex. In the category of demand or supply, the person can choose the option of barter which generally shows the possible barters, or specifically by determining the necessities can show considered ones.

The search is divided into 2 subsets, one is symbolic search which the person finds the similar items by entering the details and the second is an advanced search which the person faced with more predetermined filters.

To add a supply or demand, the information of that good or service, the complementary details and specifications, the manner of transaction, money, credit, exchanging goods or services is declared to the user. If the specified exchange is selected, the exchange is done with something else or if desired it only shows the exchange option. In the other part which is displayed under the message, a platform is provided for the server to communicate with the user and also show the suggestions. After observing an advertisement and communicating, if two parties want to interact, the communication is completed and can be said that a communication and transaction can specify as a commitment agreement and agreed price because it is negotiable. If the transaction be in the form of bartering goods and services, two parties must charge their account according to the amount of service they receive or have the required credit in the system from their bank. But in such transactions where only one person is the costumer and the other is the seller, only the costumer has to make a commitment. The price has to be written in the corresponding part according to the specified currency, so that when both parties have submitted the executive guaranty, the specific codes is submitted to the other party and approved, which this significant point if it is purchase, the money released and if it is barter, it will be returned to the account of the owner after the confirmation of the contract and if a part is barter and other part is money or credit, a part will be stored as guaranty and another as paid in the system. If the transaction is done the guaranty will be returned to the owner's account and the payable part, will be paid and if the transaction is long term, if the volume does not affect the price, only the payment time will be determined. (For instant a transaction of 100,000 dollars will be made in 10 installments. Now a person with 10,000 dollars credit in the bank can do this transaction and can do the next part, each time that she/he fulfills his commitment.) And also if the volume affects the price, the payment time has to be determined and the differences in prices should be deposited in the system as a guaranty in high and low volume. If the money is in the account or credit of funding location, the money is transferred to the other party's account after confirmation of accuracy of goods or services.

In purchase the first step of negotiation is done according to price and conditions, confirmation of price, payment in system, submitting the code for the seller which his account charged and then providing services or submitting the good where the seller has announced as well as submitting postal receipt.

In specific numbers of working days, after requesting if the costumer not approved, the prosecution should be done and the buyer will release the amount for the seller if he/she approved.

If the buyer reports devastation in the good, it should be submitted to the nearest branch. When announced that a cargo is submitting, necessary actions must be taken, includes sealing the open able parts. If the seal was not deface and the good didn't work and this confirm by the trusted representative of structure (one of the nearest offices to the buyer), the buyer's money will return and the device will submitted to the seller. All costs are calculated and deducted from the offender.

The search part, depending on a supply and demand, operates in two sides. Another advantage of this search is to link between a supply that can be a product or supply with another product or supply. Another capability of this search is based on provided priorities by the directorship of structure. For instant to get goods or services which we need more, search can, based on the priority, display the requests. The search fades the limitations. Although initially shows us the nearest options but in case there are no near options, this will offer an option in another country. In the structure of the present invention there is no limitation in terms of geographic coordinate or the language of the user. This operation can be done multilaterally. Indeed it would be better to be done for the new goods to make a commitment to the financial responsibility system, as it is possible for the second-class (used) goods. The search has a self-evolution structure which can recognize one object or service over time. The novel part of this artificial intelligence is from comments of individuals. The comments which use positive and proper expressions to describe them, especially for service, will help increase their ads. If the required goods are not available, it will check other items that are close to the requested items. For instant, for a person who is looking for a rock climbing equipments, if there is no inventory, skiing or mountain climbing equipments should be displayed in next priority, and if there are no such items, some other items in sport category should be shown.

There are two ways for the executive guaranty:

Since there is a possibility of fraud for the seller or the buyer, especially in second class goods or new electrical goods, thus it is better to divide the goods into two categories, face to face selling and delivering or postal selling and delivering. If this exchange done face to face the responsibility for the health of the goods lies with the seller and the buyer is responsible to identify them. If they want to send this product by mail the experts of system can control the appearance and send the good using the seal label.

In this structure, there is a way to give credits to the sellers and general distributers which the manner to make a credit is that the first party conclude a contract with the second party. For the payment, decide to transfer the credit through the system. The bank insures to pay the money if the first party abstains for the payment. Now the first party has negative level and the second party has positive level. In two ways the first party can increase his account from negative to zero. In two ways or after a certain period of time the same process continues between the first and third party through the common currencies or through transaction with other parties. Now the first party establish the same relationship with forth party. If the transferred credit from forth party to first party be more than what his/her withdrawal, the credit of first party become positive and otherwise it would be zero or negative and if this cycle takes place for thousands of times after a while the credits will be accepted by everyone.

In the structure of the present invention the long term transactions in which according to the request money can be released to the extent of performing the operation and provided to the other person.

Prices vary for selling a high volume product. Loading and delivery due to the high volume should be done in several stages. Now by releasing money at any stage, we can denote the guaranty of payment and purchase to the other party in the volume of the transaction. For instant in trading 300,000 ton iron ore; for shipping this lading, a 30 thousand ton ship will be needed which this shipping will be in 10 parts. For the commitment to reach the purchase, the price of 300 thousand ton and 30 thousand ton should be calculated. Now the buyer should have the credit of 30 thousand ton plus the difference in prices of 300 thousand ton and 30 thousand ton in this port. Thus it can compensate the damage in differences of prices in volume of lading in case of non-alignment to the whole purchase. It is even possible to calculate this price surplus step by step so that the buyer's right is not trampled. For example, if after purchasing 6 parts, i.e. 180,000 ton, the buyer for any reason could not continue to cooperate with the seller, due to the significant amount of purchase, for compensation the buyer must pay less, when he wants to buy 1 part and then not continue the cooperation.

In the present invention the value created for one transaction is allowed for transferring the money or remaining in the account, receiving the equivalent of the value of provided services. In this invention for created points through the operation, providing high quality services in individual's account created value and reward which by transferring this reward instead of money in a transaction, it will be possible to transfer this value and remain it in the system. Thus, with the persistence of the mentioned reward, a kind of stability rule is created that the value of the services performed, the purchased goods or any other interactions only cause the transfer of the created value unit instead of the currency. Thus, by passing the time and the possibility of increasing the unit value of this defined point will make this unit more valuable against the currency defined in the usual transactions. This increase in the value of the unit of points in the repetition of transactions will determine the process of forming a kind of digital value.

Also in ordering, buyers of goods or services will always be able to register people's orders for purchase with special and customized conditions. In this way, people can register their desired services and goods with special conditions, such as a discount with a certain amount or year of construction, a person providing services or other distinguishable items, and at a specified time and based on the priority, a sufficient information will be provided to the applicant if a sample is available in accordance with the said request.

Since value creation can be made through the presentation of individuals, Always if a person is looking to provide goods or services and other people encourage the person to buy the goods or services in question by presenting their presentation, from manufacturer factory, company provided the services or the related natural persons, an amount should be paid as commission to advertisers. In case of plurality of people and after the buyer being presented for the several times, the seller will pay the commission to last one who advertise and encourage the buyer. This amount can be given to them in the form of cash or created value.

In the method of present invention, if a person increases the value of his services in order to perform the services he provides or the goods he transfers in the form of a transaction by creating value and increasing his credit in the system account, this increase in credit itself creates value. However, if receive money for the services or provided goods, then it is not possible to create value and create new credit.

### DESCRIPTION OF DRAWINGS

FIG. 1 shows the general flowchart of system operation method.

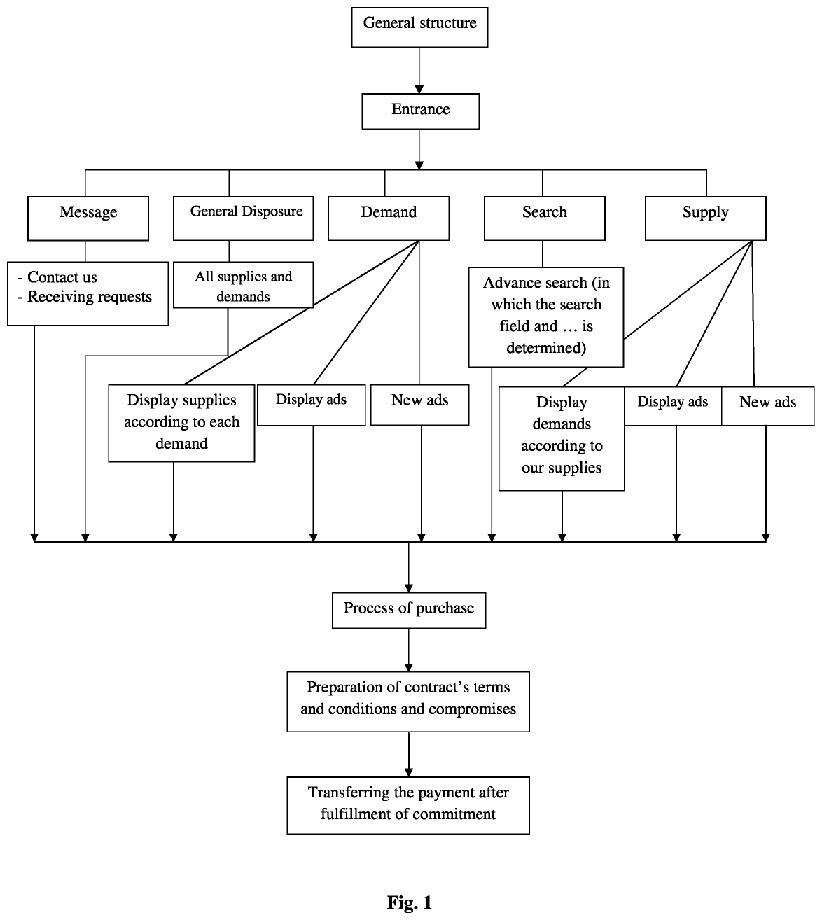

FIG. 2 shows the flowchart of how to work by system.

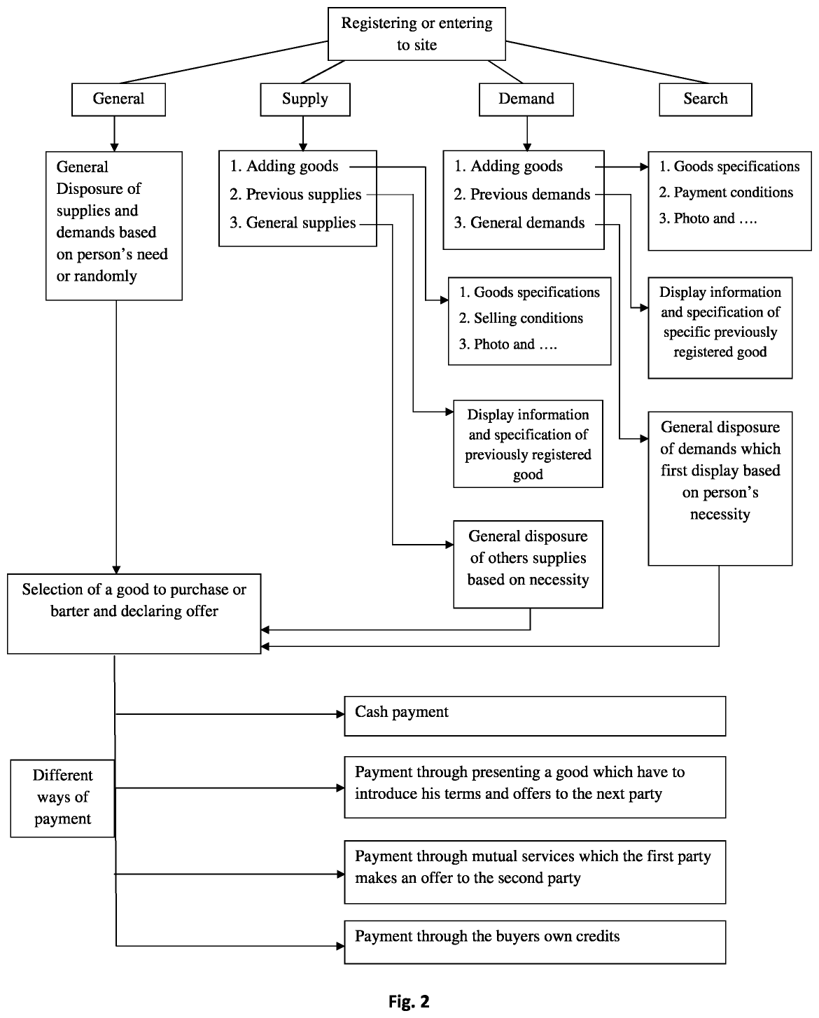

What is claimed is:

1. The invention “smart system for transferring and exchanging goods and services in the financial platform” includes at least a central server and different interactional ports, a software, the database of keeping user's information, a smart translator, a searching motor, at least a value and credit creating structure with the possibility to convert the created value into currency, an unique identifier to minimize the possibility of errors in financial operations and at least one application to create the possibility for interactions among people and especially it is a web-based system for informing, identifying and exchanging services, goods and liquidity resources with each other.

2. The invention of claim one which is a kind of system for exchanging goods for goods, services for goods or goods for services based on the existed credit in the system.

3. The invention of claim one which contains from a central server and different interactional ports.

4. The invention of claim one in which the operating observation port for the users can be various types of websites or installable applications on the personal equipments including mobiles, tablets, phone pads, different types of PCs and any system and structure usable in cyber space.

5. The invention of claim one which the operation and disposure structure of the said system is not limited to a specific language and is usable for users with any nationality and language.

6. The invention of claim one in which the system is equipped with a smart translator among different languages.

7. The invention of claim one in which there is no limitation in terms of geographic coordinate or language of user.

8. The invention of claim one which the system is equipped with a searching motor for searching and finding conventional requests of users.

9. The invention of claim one which the searching motor performs based on checking predefined items as well as exploited information and based on interpretation of filed request or offered suggestion.

10. The invention of claim one in which the system is equipped with a value and credit creating structure based on the performed interactions.

11. The invention of claim one in which there is possibility to convert the created value into currency and vice versa.

12. The invention of claim one in which it is possible to do the operations in the present platform without the need to financial structures outside the organization.

13. The invention of claim one which the unique identifier minimize the possibility of errors in financial operations or errors in sending and receiving information related to a specific transaction.

14. The invention of claim one which the use of common facial recognition mechanisms, fingerprints, iris scanning or other diagnostic structures can help for better recognition of users as an auxiliary mechanism.

15. The invention of claim one which the method and type of transaction is determined by users themselves.

16. The invention of claim one in which each person states and files his request by announcing his ability to do a service or based on another good.

17. The invention of claim one in which the said system develops and evolves itself in the form of a learning machine and along with a related dictionary for converting words and statements to a specific machine code language.

18. The invention of claim one which by using the complier, machine code language, smart translator of the system as well as backgrounds, the said codes can check all requests and match them with provided requests.

19. The invention of claim one in which users must have credit in the system in the amount of value of goods or services they want to receive.

20. The invention of claim one in which the exchange is in two ways of face to face selling and delivering or postal selling and delivering.

21. The invention of claim one which for created points through the operation, providing high quality services in individual's account, create value and reward which by transferring this reward instead of money in a transaction, it will be possible to transfer this value and remain it in the system.
